(19) United States
(12) Patent Application Publication
(10) Pub. No.: US 2013/0306525 A1
(43) Pub. Date: Nov. 21, 2013

(54) FROTH FLOTATION CONTROL

(71) Applicant: ABB RESEARCH LTD, Zurich (CH)

(72) Inventors: Axel KRAMER, Wettingen (CH); Julio Danin LOBO, Baden (CH); Laurindo DE SALLES LEAL FILHO, Sao Paulo-SP (BR); Sebastian GAULOCHER, Zofingen (CH); Marisa MARTINS, Sao Paulo-SP (BR)

(73) Assignee: ABB RESEARCH LTD, Zurich (CH)

(21) Appl. No.: 13/952,070

(22) Filed: Jul. 26, 2013

Related U.S. Application Data
(63) Continuation of application No. PCT/EP2012/051126, filed on Jan. 25, 2012.

(30) Foreign Application Priority Data
Jan. 26, 2011 (EP) 11152194.4

(51) Int. Cl. B03D 1/02

(52) U.S. Cl. CPC B03D 1/028
USPC 209/165; 209/168

(57) ABSTRACT

A system and method utilize model-based control of a froth flotation process for concentrating a desired target mineral from ground ore. The system and method exploit real time information about a surface tension of a pulp or flotation solution including the minerals. The surface tension represents exemplary additional information about the surface chemistry in the flotation process, and as such enables a refinement of a pulp model used in control of the flotation process. Ultimately, operational efficiency of a froth flotation plant is increased.

### RELATED APPLICATIONS

This application claims priority as a continuation application under 35 U.S.C. §120 to PCT/2012/051126, which was filed as an International Application on Jan. 25, 2012 designating the U.S., and which claims priority to European Application 11152194.4 filed in Europe on Jan. 26, 2011. The entire contents of these applications are hereby incorporated by reference in their entireties.

### FIELD

The present disclosure relates to the field of minerals processing. More particularly, the present disclosure relates to the control of froth flotation processes for extracting a desired type of mineral from a pulp including ground ore, water and chemicals.

### BACKGROUND INFORMATION

Froth flotation in mineral processing industry is widely used for the extraction of a specific type of mineral from ground ore while depressing the amount of undesired minerals (gangue) in the concentrate. Froth flotation enables mining of low-grade and complex ore bodies that otherwise would be disregarded due to lack of profitability.

In a flotation cell, ground ore is fed as an aqueous pulp into a vessel with an agitator or impeller. Air bubbles are blown through the pulp and rise to the liquid surface. By adding chemical agents (collectors) to the pulp, the desired mineral is selectively rendered more hydrophobic, thus increasing separability of hydrophobic and hydrophilic particles. The hydrophobic mineral particles in the pulp may attach to small air bubbles which lift the particles to the liquid surface. At the surface, a froth layer builds up, which is then skimmed to harvest the concentrate, while the wetted gangue material remains in the liquid pulp phase, eventually leaving the cell through a tailings outlet at the bottom. Several flotation cells may be interconnected with other elements (e.g. cyclones, mills, mixing tanks) in order to yield a flotation circuit suitable for the extraction of a particular mineral type (e.g., sphalerite, a zinc mineral). Finally, different flotation circuits together with a crusher, grinding circuit, thickener, and dryer may be combined in order to form a concentrator used for extracting several mineral types from the same ore.

An important element in flotation circuit control includes accurate knowledge about the quantitative composition of the feed material and of the material at different locations in the circuit. A corresponding process parameter in this respect is the mass content of the specific minerals and the overall solid fraction, which may be monitored using an X-ray analyzer. Furthermore, air flow rate, froth level and froth thickness may be measured in each cell, while the pulp flow rate is measured in specific locations in the circuit. The sensor signals may be used as input to control and optimize a flotation circuit.

A control strategy for a flotation circuit based on model predictive control using mixed-logical dynamical systems and tested in a zinc flotation circuit is described in a paper by S. Gaulocher, E. Gallestey, and H. Lindvall, entitled “Advanced process control of a froth flotation circuit”, V International Mineral Processing Seminar, October 22-24, (2008), Santiago, Chile. The authors' objective was to maximize the production value or yield by making optimal use of the available circuit instrumentation, i.e. actuators, sensors and low-level control loops.

Model Predictive Control requires three to four main ingredients: a dynamic model of the process, measurements or estimates of the internal state variables (such as pulp phase composition in each cell of the circuit), an objective function to be optimized, and possibly constraints. Generally, control performance increases with the accuracy of the process model. However, this comes at the cost of higher instrumentation requirements because process model complexity and type, number, and positioning of the sensors must match.

In the above paper, a first-principles model based on physical insight was used. As only limited knowledge—the pH—about the pulp phase of the cell was available, the pulp model was restricted to volume and mass conservation, and assumed perfect mixing.

In general, for controlling a froth flotation plant only limited in-situ measurement information about the surface chemistry of the solid/liquid mixture is available. The lack of knowledge about the surface chemistry precludes operation and control of the plant at its optimum efficiency. This, in turn, reduces the lifetime and profitability of the plant and represents a waste of natural resources.

The efficiency of a flotation process with long-chain collectors is very much dependent on the surface tension of the flotation solution, as reported by M. Martins, L. S. Filho and B. K. Parekh “Surface tension of flotation solution and its influence on the selectivity of the separation between apatite and gangue minerals”, Minerals and Metallurgical Processing Vol.26, No.2, p.79, (2009). In the experiments reported, the surface tension is determined by the occasional retrieval of samples from a flotation solution and subsequent analysis of the samples by means of laboratory instruments, entailing a considerable time-delay between the generation of a sample and the availability of the corresponding surface tension value.

### SUMMARY

An exemplary embodiment of the present disclosure provides a system for controlling a froth flotation process in a flotation circuit. The exemplary system includes a surface tension sensor configured to measure continually a surface tension of a pulp contained in a flotation cell of the flotation circuit. In addition, the exemplary system includes a controller configured to control the flotation process based on a model of the flotation circuit taking into account the surface tension of the pulp measured by the sensor.

An exemplary embodiment of the present disclosure provides a method of controlling a froth flotation process in a flotation circuit. The exemplary method includes measuring continually a surface tension of a pulp contained in a flotation cell of the flotation circuit, and controlling the flotation process based on a model of the flotation circuit taking into account the measured surface tension of the pulp.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a froth flotation cell with a control system according to an exemplary embodiment of the present disclosure; and

FIG. 2 shows a froth flotation cell with a sensor system inserted in a bypass configuration, according to an exemplary embodiment of the present disclosure.

### DETAILED DESCRIPTION

Exemplary embodiments of the present disclosure provide a system and method for controlling a forth flotation process. The system and method of the present disclosure increase the operational efficiency of a froth flotation plant, and improve the controllability of a froth flotation process in the minerals industry.

According to an exemplary embodiment, the present disclosure provides for the control of a froth flotation process for concentrating a desired target mineral from ground ore exploits real-time or online information about a surface tension of a pulp or slurry including the minerals. The surface tension represents exemplary additional information about the surface chemistry in the flotation process, and as such enables a refinement of a pulp model used to control the flotation process. Measuring the surface tension continually or repeatedly (e.g., every few minutes) and in-situ either directly in the flotation cell or in a by-pass of the flotation cell produces valuable real-time measurement samples as a basis for future process control actions. Hence, a basic idea of the present disclosure includes a continuous monitoring of a surface tension, or of any related parameter, of the pulp in view of improved process efficiency. In conjunction with various other sensor signals, control actions or set-points for the manipulated variables such as air flow rate, froth layer level and thickness, and addition of chemicals are determined.

The controlled froth flotation process is part of a flotation circuit with at least one flotation cell including a sensor for measuring a surface tension at a specific location in the pulp contained in the cell. Accordingly, a control model of the flotation circuit includes a model of the flotation cell, which in turn includes a model of the pulp phase taking into account the surface tension of the pulp as measured by the sensor.

In accordance with an exemplary embodiment of the present disclosure, the sensor system includes a temperature sensor for measuring the temperature of the pulp. Since the surface tension is temperature dependent (e.g., for aqueous solutions 0.14 (mN/m)/K), adding a temperature sensor to the sensor system allows for the compensation of thermal variations in the surface tension signal. Furthermore, a viscosity sensor and/or a pressure sensor may be additionally included, with their respective measurements likewise being employed for compensating the surface tension signal. In this context, a combined sensor system may integrate into a single device various sensors for measuring parameters relevant to surface chemistry, such as dynamic surface tension, temperature, viscosity, pressure, pH, etc.

In accordance with an exemplary embodiment of the present disclosure, additional sensors of either one of the aforementioned kinds may be provided at further locations in the flotation cell, and used to compensate for inhomogeneous pulp properties. For example, a second surface tension sensor may be provided at a height in the flotation cell that is different from a height of a first surface tension sensor. Measurement of the surface tension at two or more locations of different height may be used for compensation of pressure variation due to fluctuating filling levels in the flotation cell.

Surface tensiometers are available from various sources, wherein experience on an industrial scale has been gained for applications like cleaning baths for the automotive industry or de-inking processes in paper industry. A suitable surface tension sensor may be a differential bubble tensiometer with two nozzles of different diameter producing bubbles in the fluid at a certain rate, as disclosed in U.S. Pat. No. 6,085,577, the entire contents of which are incorporated herein by reference in its entirety. In such a configuration, fluctuating fluid levels and the corresponding influence of hydrostatic pressure are compensated for automatically. At the same time, viscosity effects may be compensated for by suitably adjusting the bubble rate.

Generally, flotation cells are arranged in flotation circuits with an individual cell being fluidly connected to up to three other cells (feed, concentrate, tailings). In such a configuration, the surface tension measured in a first flotation cell may also be exploited to control a flotation process in a further or second cell, for example, by suitable interpolation or extrapolation, thus saving corresponding investments.

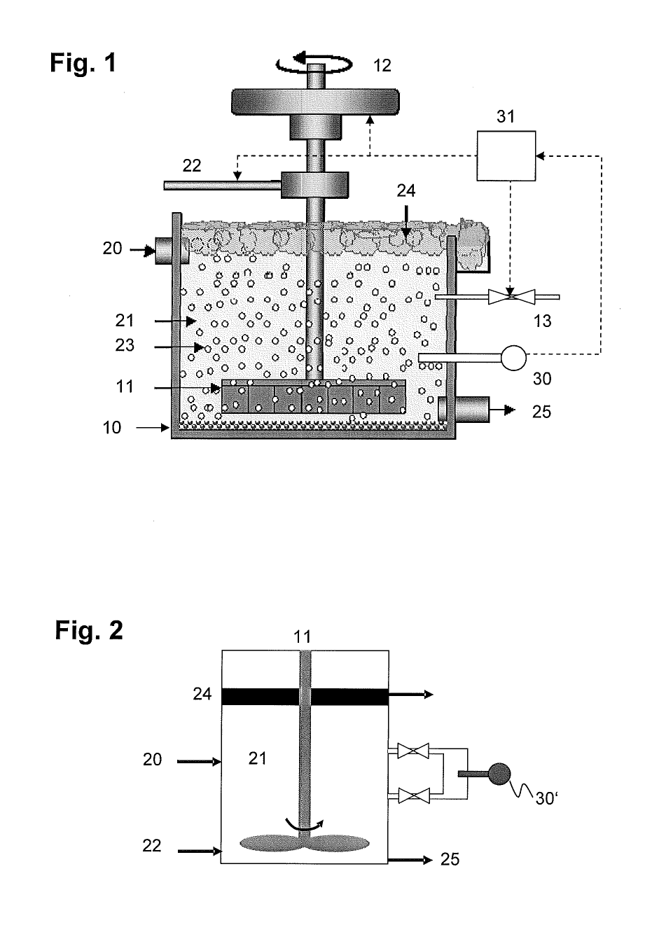

FIG. 1 schematically depicts a froth flotation cell with a vessel or mixing tank 10 and an agitator or stirrer 11 driven by a motor 12. An aqueous pulp including ground ore is fed, via in-feed 20, to slurry 21. Suitable chemicals (e.g., collectors, frothers, modifiers, pH-regulators) are added to the slurry via dosage valve 13. Air is injected, through air-supply 22, into the slurry 21, and forming bubbles 23 rising to the surface of the slurry. At the surface, a froth layer 24 develops, while tailings are removed from the vessel at outlet 25. A controller 31 receives sensor signals from sensor 30 and controls the motor 12, air-supply 22, and dosage valve 13 in response.

The material separation in the froth flotation cell is based on a physico-chemical process which in turn depends on the wettability of the mineral surface. Accordingly, surface active chemicals are used to control wetting of specific materials. Rising bubbles collect chemically modified hydrophobic particles and form a froth layer at the surface. The concentrated material in the froth is recovered by skimming.

Further sensors and measurement systems which are not depicted in FIG. 1 may include, for example, volume flow sensor and X-ray analyzer for analysis of the pulp at different locations in the flotation circuit, as well as meters for determining at least one of a pulp level, froth layer level and froth thickness. Likewise, machine vision systems may be applied to determine froth color, froth bubble size distribution or pulp bubble size distribution. In addition to agitator speed, air flow rate, and addition rate of various chemicals, pulp feed rate through the in-feed and tailings release rate through the outlet represent control parameters, which are regulated by their respective set-points, actuators (valves) and feedback loops under the control of a controller. Set-points for low-level closed control loops such as pH, fluid level or froth layer thickness may likewise be determined by the controller. For example, the controller may also determine a target value or set-point for the surface tension in a certain flotation cell, which is then subject to low-level feedback control via controlled addition of surface-tension-adjusting chemicals.

Sensor 30 continually measures surface tension of the aqueous pulp, as well as temperature and, optionally, also viscosity, density and hydrostatic pressure. Hence, sensor 30 is an industry-grade process tensiometer providing continuous, on-line information of surface tension of the pulp.

FIG. 2 shows a flotation cell with a sensor system inserted in a bypass configuration, where the pulp is brought through some process pipes and valves to the location of the tensiometer 30′. The flow at the sensor 30′ may be controlled to prevent turbulences, and may even be temporarily interrupted in order to generate a calm measurement environment.

Since the mixing of the slurry in the flotation cell will neither result in a perfectly homogeneous distribution of particles, water and surfactants nor in a uniform distribution of temperature or other process parameters, such as surface tension or viscosity, a plurality of sensors may be provided at different locations. These sensors provide spatially further resolved information about the flotation process which may be exploited by a correspondingly refined process model. On the other hand, a plurality of sensors allows for averaging the corresponding signals, and thus enables a more efficient feedback control of the process.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A system for controlling a froth flotation process in a flotation circuit, comprising:
a surface tension sensor configured to measure continually a surface tension of a pulp contained in a flotation cell of the flotation circuit; and
a controller configured to control the flotation process based on a model of the flotation circuit taking into account the surface tension of the pulp measured by the sensor.

2. The system according to claim 1, comprising:
a temperature sensor configured to measure a temperature variation of the pulp,
wherein the controller is configured to compensate the measured surface tension for the measured temperature variation.

3. The system according to claim 2, comprising:
a viscosity sensor configured to measure a viscosity variation of the pulp,
wherein the controller is configured to compensate the measured surface tension for the measured viscosity variation.

4. The system according to claim 2, comprising:
a pressure sensor configured to measure a pressure variation of the pulp at the location of the sensor,
wherein the controller is configured to compensate the measured surface tension for the measured pressure variation.

5. The system according to claim 2, wherein:
the surface tension sensor is arranged at a first height in the flotation cell,
the system comprises a second surface tension sensor configured to measure a surface tension of the pulp at a second height in the flotation cell different from the first height, and
the model of the flotation circuit takes into account a difference between surface tension values measured at the first and second height.

6. The system according to claim 2, wherein the surface tension sensor includes a differential bubble tensiometer.

7. The system according to claim 1, wherein the controller is configured to control a froth flotation process in a further flotation circuit including a further flotation cell fluidly connected to an in-feed or outlet of the flotation cell and based on the surface tension of the pulp measured by the surface tension sensor in the flotation cell.

8. The system according to claim 3, comprising:
a pressure sensor configured to measure a pressure variation of the pulp at the location of the sensor,
wherein the controller is configured to compensate the measured surface tension for the measured pressure variation.

9. The system according to claim 3, wherein:
the surface tension sensor is arranged at a first height in the flotation cell,
the system comprises a second surface tension sensor configured to measure a surface tension of the pulp at a second height in the flotation cell different from the first height, and
the model of the flotation circuit takes into account a difference between surface tension values measured at the first and second height.

10. The system according to claim 9, wherein the surface tension sensor includes a differential bubble tensiometer.

11. The system according to claim 1, wherein:
the surface tension sensor is arranged at a first height in the flotation cell,
the system comprises a second surface tension sensor configured to measure a surface tension of the pulp at a second height in the flotation cell different from the first height, and
the model of the flotation circuit takes into account a difference between surface tension values measured at the first and second height.

12. A method of controlling a froth flotation process in a flotation circuit, comprising:
measuring continually a surface tension of a pulp contained in a flotation cell of the flotation circuit; and
controlling the flotation process based on a model of the flotation circuit taking into account the measured surface tension of the pulp.

13. The method according to claim 12, comprising
measuring a temperature variation of the pulp; and
compensating the measured surface tension for the measured temperature variation.

14. The method according to claim 12, comprising:
measuring the surface tension with a differential bubble tensiometer.

15. The method according to claim 13, comprising:
measuring the surface tension with a differential bubble tensiometer.
